(19) United States
(12) Patent Application Publication
(10) Pub. No.: US 2009/0313634 A1
(43) Pub. Date: Dec. 17, 2009

(54) Dynamically selecting an optimal path to a remote node

(76) Inventors: Diep T. Nguyen, Boothwyn, PA (US); Mark D. Luba, Plymouth Meeting, PA (US)

Correspondence Address: UNISYS CORPORATION, UNISYS WAY, MAIL STATION: E8-114, BLUE BELL, PA, 19424, US

(21) Appl. No.: 11/384,994

(22) Filed: Mar. 20, 2006

Related U.S. Application Data
(60) Provisional application No. 60/723,032, filed on Oct. 3, 2005.

(51) Int. Cl. G06F 9/46

(52) U.S. Cl. 718/105

(57) ABSTRACT

In a multi-cell system, a dynamic adjustment of a workload of a data path between multiple cells of the system may be preferred to eliminate system latencies during operation of the system. The dynamic adjustment may include monitoring a workload, or an amount of data traffic, of a data path and determining if the monitored workload of the data path exceeds a predetermined workload threshold. If the workload threshold is exceeded, the dynamic adjustment of the workload of the data path may include transferring a portion of data from the monitored data path to another data path that is also connected to the same cells as the monitored data path. The transfer of data may be to a previously-existing data path that has capacity for the data, to a newly-created data path, or to both a previously-existing data path and a new data path.

### REFERENCE TO RELATED APPLICATIONS

This application claims priority to U.S. Provisional Application No. 60/723,032, filed on Oct. 3, 2005 and entitled “Method for Dynamically Selecting an Optimal Path to a Remote Node,” the contents of which are hereby incorporated by reference in their entirety.

### FIELD OF THE INVENTION

The current invention relates generally to data processing systems and more particularly to a dynamic selection of an optimal path between cells of a data processing system.

### BACKGROUND OF THE INVENTION

A multi-processor or multi-cell system may perform operations that require the transmission of data between processors or cells, which may incorporate data paths between the various cells of a system for the data transmission. The system may experience latencies when the data paths become over-burdened by heavy loads of data traffic on the data paths. While one data path is performing slowly due to a large amount of data traffic, for which the path may be responsible for transmitting between two cells, another data path may only be slightly, or perhaps not at all, burdened. There is a clear need for balancing the data traffic among the data paths in order to minimize system latencies.

Load-balancing of data paths typically is configured before the system is running. Such a mechanism may, for example, use a previously-configured distribution to determine an efficient way of distributing the data among the various paths. However, as the system is running, the data distribution may change. For example, unexpected data requests or transfers may occur, resulting in an irrelevant distribution scheme. Accordingly, a mechanism for dynamically load-balancing data paths between cells of a multi-cell system during operation of the system is desired.

### SUMMARY OF THE INVENTION

A dynamic adjustment of a data path's workload may include determining if a monitored workload, or amount of traffic, of the data path exceeds a predetermined workload threshold. The predetermined workload threshold may be specific to the particular data path.

The dynamic adjustment of the workload of the data path may include transferring a portion of data from the monitored data path to another data path that is also connected to the same cells as the monitored data path. The transfer of data may be to a previously-existing data path that has capacity for the data, to a newly-created data path, or to both a previously-existing data path and a new data path.

This Summary of the Invention is provided to introduce a selection of concepts in a simplified form that are further described below in the Detailed Description of Illustrative Embodiments. This Summary of the Invention is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of the invention are better understood when read in conjunction with the appended drawings. Exemplary embodiments of the invention are shown in the drawings, however it is understood that the invention is not limited to the specific methods and instrumentalities depicted therein. In the drawings:

FIG. 1 is a block diagram representing an exemplary computing device in which the present invention may be implemented;

FIG. 2 is a block diagram of an example dynamic workload management system according to an embodiment;

FIG. 3 is a block diagram of an example workload management controller according to an embodiment;

FIG. 4 is a flow diagram of an example dynamic workload management method according to an embodiment; and

FIG. 5 is a flow diagram of an example dynamic workload management method according to an additional embodiment.

### DETAILED DESCRIPTION OF ILLUSTRATIVE EMBODIMENTS

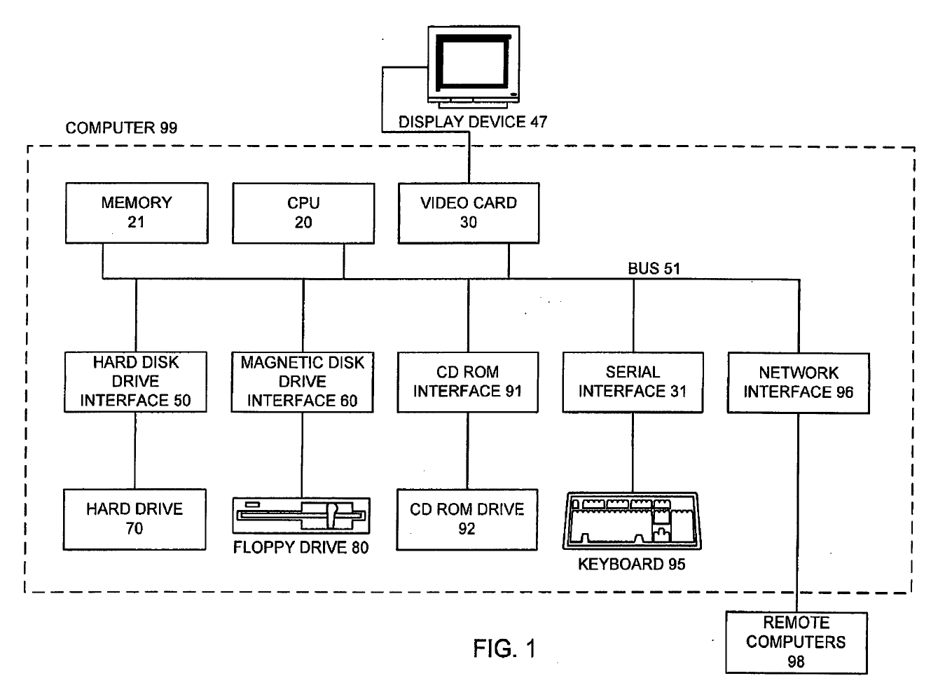

FIG. 1 is a block diagram illustrating hardware and software components of an exemplary computing environment in which a dynamic selection of an optimal path between cells of a data processing system, in accordance with the present invention, may be implemented. A computer 99, which may also function as a network server, includes conventional computer hardware components including a Central Processing Unit (“CPU”) 20, a system memory 21, and a system bus 51 that couples the system memory 21 to CPU 20 and other computer system 99 components. The system memory 21 typically includes read only memory (ROM), random access memory (RAM) or other conventional known memory types. Instructions comprising application program modules are typically stored in and retrieved from memory 21 by CPU 20, which executes said instructions.

A user may enter commands and other input into the computer 99 via input devices such as a keyboard 95, mouse, scanner or other input device. In exemplary computer system illustrated, the keyboard 95 is coupled to CPU 20 via a serial interface 31 coupled to system bus 51.

A display device 47 is also coupled to the system bus 51 via a video graphics adaptor card 30. The display device 47, which may be a CRT monitor, LCD terminal or other display, includes a screen for the display of information which is visible to the user.

The computer 99 may also function as a server connected in a LAN, WAN or other networked environment. The computer 99 is thus connected to other remote computers 98 (e.g., personal computers, routers, servers, clients) via a local area network interface 96, modem or other communications device.

The computer 99 may also include storage media, such as hard drive 70, floppy drive 80, and CD ROM drive 92. Other computer storage media may also be used in the exemplary computing environment. The hard drive 70 may be connected to the system bus 51 through an interface, such as hard disk drive interface 50. The floppy drive 80 may be connected to the system bus 51 though a magnetic disk drive interface 60, while the CD ROM drive 92 may be connected to the system bus 51 through a CD ROM interface 91.

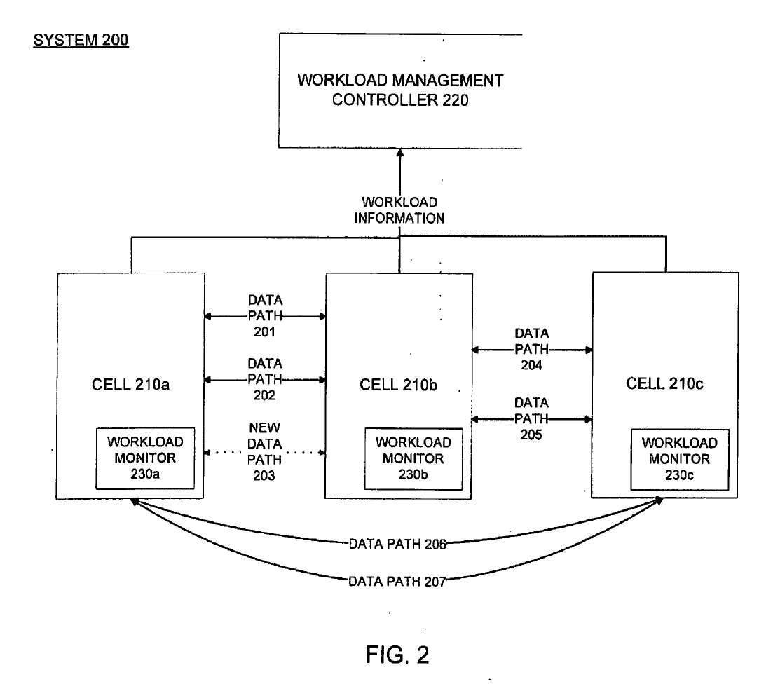

FIG. 2 is a block diagram of a dynamic workload management system 200 for managing a workload of data paths between cells. The dynamic workload management system 200 may include multiple cells, such as cell 210a, cell 210b, and cell 210c. The system 200 is not limited to a particular number of cells, and it is envisioned that any number of cells are possible within the scope of the invention.

The cells 210a, 210b, and 210c may communicate through multiple data paths 201-207. The communication may involve a transferring, accessing, or sharing of data. A workload of a path may be defined as the amount of data traffic on the path. Data communicated between the cells 210a, 210b, and 210c on the data paths 201-207 may occupy resources of each of the cells 210a-210c involved in the communication. Furthermore, a large volume of data traffic may result in system latencies. The latencies may be reduced through managing the amount of data traffic on the data paths during operation of the system 200.

Each cell of the system 200 may include a workload monitor 230. For example, as shown in FIG. 2, cell 210a includes workload monitor 230a, while cells 210b and 210c include workload monitors 230b and 230c, respectively. The workload monitor 230 may be responsible for monitoring a workload of a path between the cell of the workload monitor 230 and another cell. For example with reference to FIG. 2, workload monitor 230a may monitor the workload of data path 202 between cell 210a and cell 210b. Similarly, workload monitor 230b of cell 210b may also monitor the workload of data path 202, in addition to the workload of data path 204 between cell 210b and cell 210c.

In addition to monitoring the workloads of data paths of its cell 210, the workload monitor 230 may also determine if the monitored workload exceeds a predetermined workload threshold, such as a predetermined maximum amount of traffic, for the data paths 201-207. This determination may be made by a comparison of the monitored workload with the predetermined workload threshold. The predetermined workload threshold may be a threshold based on previously-obtained data of the system 200 and may be different for each data path 201-207. The predetermined workload threshold may also be determined based upon traffic types or resources of the system 200. If the monitored workload exceeds the predetermined workload threshold, the workload monitor 230 may provide an indication of such excess to a workload management controller 220.

In addition, if the monitored workload is exceeded, the workload monitor 230 may wait a predetermined amount of time before providing an indication to the workload management controller 220. For example, if workload monitor 230c determines that data path 205 has exceeded the predetermined threshold for data path 205, workload monitor 230c may wait a predetermined period of time, which may change or be adjusted throughout system operation depending on system resources, to ensure that the data traffic of data path 205 continues to be excessive. The data traffic may be reduced, for example, causing a notification of excessive data traffic to be erroneous or insignificant.

The workload management controller 220, upon receipt of information from the workload monitor 230 that the monitored workload exceeds a predetermined, maximum workload, such as a maximum amount of traffic, may operate to dynamically adjust the workload of the monitored data path. The dynamic adjustment performed by the workload management controller 220 may be performed in a variety of ways. The workload management controller 220 may determine that a second data path between the cells of interest is under-utilized. The under-utilization of the second data path may be that the amount of traffic on the second data path is below the data path's predetermined traffic threshold, for example. The dynamic adjustment may include transferring a portion of data from the monitored data path to a second data path. The portion of data that is transferred between the monitored data path and the second data path may include an amount of data so that both the monitored data path and the second data path are under their respective predetermined workload thresholds. The portion of data transferred may include an amount of data so that the data on the monitored data path and the second data path is approximately the same. The transferred amount of data may be, for example, an amount so that both the monitored data path and the second data path are below their respective workload thresholds by a predetermined percentage. The workload management controller 220 may decide on the allocation and the transfer amount of the data.

For example, suppose workload monitor 230c of cell 210c determines, through a comparison operation with a threshold value, that the workload of data path 206 between cells 210a and 210c exceeds the threshold value. Workload monitor 230c may relay this information to the workload management controller 220. The workload management controller 220 may then determine that data path 207, also between cells 210a and 210c, is under-utilized, as its amount of traffic, for example, is below the predetermined threshold value. The controller 220 may then transfer a portion of data from data path 206 to data path 207. The transfer may be performed so that both data paths 206 and 207 are below their respective threshold values of data traffic after the transfer.

The dynamic adjustment performed by the workload management controller 220 may include the creation of a new data path in order to relieve a data path of an excessive workload. When a determination has been made, by a workload monitor 230 for example, that a monitored data path's workload has exceeded a predetermined workload threshold, then the workload management controller 220 may create a new data path between the cells that the monitored data path connects. After the creation of a new data path, the workload management controller 220 may transfer a portion of data from the monitored data path to the new data path. The portion of data that is transferred between the monitored data path and the new data path may include an amount of data so that both the monitored data path and the new data path are under their respective predetermined workload thresholds. The portion of data transferred may include an amount of data so that the data on the monitored data path and the new data path is approximately the same. The transferred amount of data may be, for example, an amount so that both the monitored data path and the new data path are below their respective workload thresholds by a predetermined percentage. The workload management controller 220 may decide on the allocation and the transfer amount of the data.

With reference to FIG. 2 and the dynamic workload management system 200, workload monitor 230a of cell 210a may determine, upon monitoring a workload, such as an amount of traffic, of data path 201 between cells 210a and 210b, that the workload of data path 201 exceeds a workload threshold. The workload threshold may be determined by previous activity of cells 210a and 210b, for example. Upon this determination, the workload monitor 230a may transmit this information to the workload management controller 220. Or, the workload monitor 230a may wait a predetermined period of time to ensure that the excessive workload of data path 201 continues. If, after the predetermined period of time elapses, the workload of data path 201 continues to exceed the predetermined workload threshold, then the workload monitor 230a may transmit this information to the workload management controller 220. The workload management controller 220 may create new data path 203 between cells 210a and 210b and may then transfer a portion of data from the monitored data path 201 to the new data path 203.

Alternatively, a transfer of a portion of data from a monitored path to a second path, as well as a transfer of a portion of data to a new path, may be part of the workload management controller's adjustment of the monitored path, when it is determined that the monitored path has exceeded a predetermined workload threshold. For example, with reference to FIG. 2 and the system 200, if the workload monitor 230b determines, through a comparison operation for example, that data path 202 has exceeded a predetermined workload threshold, the workload monitor 230b may relay a workload excess indication to the workload management controller 220. The workload management controller 220 may then determine that a transfer of a portion of data from data path 202 to data path 201 is not sufficient to adjust the workload of data path 202. For example, transferring enough data from data path 202 to data path 201 to ensure that the workload of data path 201 is not excessive, may result in an excessive workload on data path 201, such that the workload of data path 201 would exceed a predetermined workload threshold. Accordingly, the workload management controller 220 may create a new data path, such as new data path 203. A portion of data from data path 202 may then be transferred to both data path 201 and new data path 202. The transfer may ensure that the workload, or amount of traffic, of each data path 201, 202, and 203 does not exceed the workload threshold value. The transfer may also ensure, for example, that the workload of each data path 201, 202, and 203 is a below their respective predetermined workload thresholds by a predetermined amount.

The determination of a monitored workload exceeding the predetermined threshold workload may be made by the workload management controller 220 instead of the workload monitor 230. The workload monitor 230 may provide monitored workload information to the workload management controller 220. This information may then be used by the workload management controller 220 to perform a comparison with the predetermined threshold workload. If an excess of data traffic is detected, the workload management controller 220 may then perform an appropriate dynamic adjustment of the workload.

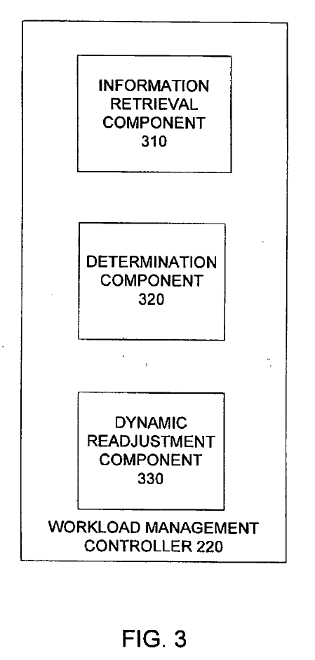

FIG. 3 is a block diagram of a workload management controller 220 according to an embodiment of the invention. The workload management controller 220 includes several means, devices, software, and/or hardware for performing functions, including a information retrieval component 310, a determination component 320, and a dynamic readjustment component 330, which may operate to dynamically adjust a monitored workload of a data path when it is determined that the monitored workload has exceeded a predetermined workload threshold.

The information retrieval component 310 may be responsible for obtaining information related to a monitored workload of a data path between two cells, such as cells 210a, 210b, and 210c. The information may include an indication that the monitored workload of the data path exceeds a predetermined workload threshold. This indication may come from a workload monitor, such as workload monitor 230a, 230b, or 230c of the dynamic workload management system 200. Or, the information may include monitored workload information, such as an amount of data traffic of the data path between the two cells. If the information retrieval component 310 receives monitored workload information, instead of an indication of workload excess for example, then the determination component 320 of the workload management controller 220 may compute if the monitored workload exceeds a predetermined workload threshold. The determination component 320 may also compute if a predetermined period of time should be incorporated before a dynamic adjustment of the data path occurs. In addition, the determination component 320 may also be responsible for deciding to dynamically readjust the monitored workload of the data path between the two cells, such as cell 210a and 210c.

The dynamic readjustment component 330 may dynamically readjust the monitored workload of the data path. The dynamic readjustment may occur if the information retrieval component receives an indication, from a workload monitor 230 of one of the two cells for example, that the monitored workload of the data path between the two cells exceeds a predetermined workload threshold. The dynamic readjustment may include a transfer of a portion of data from the monitored data path to a second data path. The second data path may be an under-utilized path. The dynamic readjustment may be a transfer of a portion of data from the monitored data path to a newly-created data path. Or, the dynamic readjustment may be a combination of transfers, such as a transfer of a portion of data to the second data path and a transfer of a portion of data to the newly-created data path. The transfer of data from the monitored path to an under-utilized path, a newly-created path, or both may result in an amount of data on each of the data paths so that the workload of each is under its respective predetermined workload threshold.

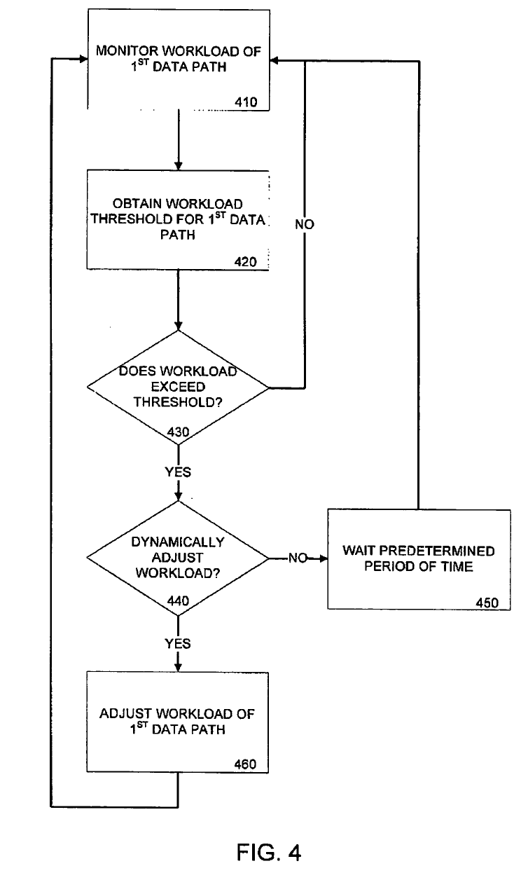

A dynamic workload management method is described with respect to the flow diagram of FIG. 4. At 410, a workload of a first data path is monitored. The first data path may be monitored by a workload monitor 230 of one of the cells to which the first data path is connected. For example with reference to the system 200 of FIG. 2, workload monitor 230b of cell 210b or workload monitor 230c of cell 210c may monitor data path 205 as data path 205 connects cells 210b and 210c. Monitoring the workload of the first data path may include monitoring an amount of data traffic on the first data path, for example.

At 420, a predetermined workload threshold for the first data path is obtained. The predetermined workload threshold may vary for data paths of the system 200 and may be dependent upon previous system statistics, for example. At 430, an analysis is conducted to determine if the monitored workload of the first data path exceeds the predetermined workload threshold. If the monitored workload of the first data path does not exceed the workload threshold, then a dynamic workload adjustment may not be preferred as the monitored data path is not over-extended or over-utilized. The method then proceeds back to 410 to continue monitoring the workload of the first data path

If it is determined at 430 that the monitored workload of the first data path does exceed the predetermined workload threshold, then the method may proceed to 440, where an analysis is conducted to determine if the monitored workload should be dynamically adjusted. The system 200 may, for example, dictate that an initial determination of an excessive workload on a data path should not result in a dynamic adjustment of the workload. If a dynamic workload adjustment is not needed or is not preferred based on, for example, various system parameters, then at 450, the system 200 may wait a predetermined period of time. Then the method may proceed to 410 to monitor the workload of the first data path.

If, at 440, it is determined that the workload of the first data path should be adjusted, then the adjustment is performed at 450. After the dynamic adjustment at 450, the data path may continue to be monitored, at 410, in order to determine if later adjustments to its workload may be desired.

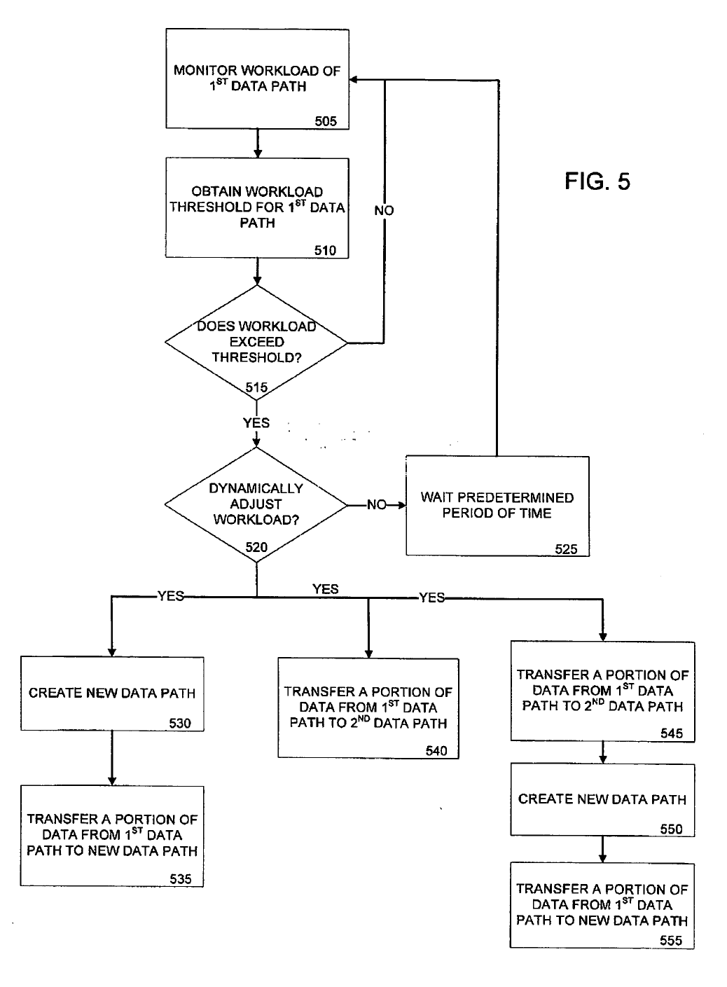

A dynamic workload management method according to another embodiment is described with respect to the flow diagram of FIG. 5. Similar to the dynamic workload management method of FIG. 4, at 505, a workload of a first data path is monitored. At 510, the workload threshold value for the first data path is obtained in order to assist in the determination of the dynamic adjustment of the workload. At 515, a comparison of the monitored workload of the first data path with the predetermined workload threshold is computed, and if the monitored workload does not exceed the threshold value, then the dynamic workload management method proceeds to 505 to continue monitoring the first data path.

If instead the comparison at 515 indicates that the monitored workload of the first data path does exceed the workload threshold, then at 520 a decision is made whether the workload should be dynamically adjusted. If the workload should not be adjusted, then at 525, a predetermined period of time elapses before proceeding to 505 to continue monitoring the workload of the first data path. If, at 520, it is decided that the workload of the first data path should be dynamically adjusted, then the method proceeds to 530, 540, or 545.

At 530, a new data path is created. The new data path may be created in order to alleviate the workload of the first data path. After the creation of the new data path, at 535, a portion of data from the first data path is transferred to the new data path. The transfer may result in both data paths, the new data path and the first data path, having a workload, or an amount of traffic, that does not over-burden the system 200 or cause system latencies.

At 540, as an alternative to creating a new data path, a portion of data from the first data path is transferred to an existing, second data path. The second data path may also be a path between the same cells as that of the first data path.

An additional alternative for dynamically adjusting the workload of the first data path includes, at 545, transferring a portion of data from the first data path to an existing, second data path, as well as, at 550, creating a new data path. The new data path may be a path between the same cells as that of the first and second data paths. After the new data path is created, a portion of the data from the first, over-burdened data path is transferred to the new data path, at 555. Both transfers from the first data path to the second data path and to the new data path may result in each of the three data paths having a workload below their respective predetermined workload thresholds.

The option to transfer a portion of data from the first data path to the new data path (535), to transfer a portion of data from the first data path to the second data path (540), or to transfer a portion of data from the first data path to the second data path and to the new data path (545 and 555) may be decided by the workload management controller 220 so that optimal workloads of each of the involved data paths are achieved. For example, the workload management controller 220 may define as an optimal case for the system 200 as each of the data paths having a workload 10% below their predetermined workload threshold. Other definitions or preferences may be utilized.

Alternatively, the workload management controller 220 may define a hierarchy of preferred transfer mechanisms. For example, the workload management controller 220 may dictate that a portion of data should be transferred to a pre-existing data path (540), if possible. If this option is not possible, because for example such a transfer would overload the pre-existing, second data path, then the workload management controller 220 may dictate a second-preferred option. Finally, if the second-preferred option is not feasible, then a third option may be utilized. For example, the workload management controller 220 may define the following order for data transfers: option 540; option 530 if option 540 is not viable; then options 545 and 555 if option 530 is not viable. Other option arrangements are possible.

As mentioned above, while exemplary embodiments of the invention have been described in connection with various computing devices, the underlying concepts may be applied to any computing device or system in which it is desirable to implement a multi-cell system. Thus, the methods and systems of the present invention may be applied to a variety of applications and devices. While exemplary names and examples are chosen herein as representative of various choices, these names and examples are not intended to be limiting. One of ordinary skill in the art will appreciate that there are numerous ways of providing hardware and software implementations that achieves the same, similar or equivalent systems and methods achieved by the invention.

As is apparent from the above, all or portions of the various systems, methods, and aspects of the present invention may be embodied in hardware, software, or a combination of both.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims.

1. A computer-implemented workload management method, comprising:
monitoring a workload of a first data path between a first cell and a second cell of a multi-cell system;
determining if the monitored workload exceeds a predetermined workload threshold;
creating a new data path between the first cell and the second cell; and
dynamically adjusting the workload of the first data path between the first cell and the second cell by transferring at least a portion of the workload from the first data path to the new data path.

2. The method of claim 1, wherein monitoring a workload of a first data path between the first cell and the second cell comprises monitoring an amount of traffic on the first data path.

3. The method of claim 1, wherein determining if the monitored workload exceeds a predetermined workload threshold comprises comparing an amount of traffic on the first data path to a predetermined amount of traffic.

4. The method of claim 1, wherein dynamically adjusting the workload of the first data path between the first cell and the second cell comprises transferring at least a portion of data from the first data path to a second existing data path.

5. The method of claim 4, wherein transferring a portion of data from the first data path to the second data path comprises transferring an amount of data so that the first data path and the second data path are under the predetermined workload threshold.

6. (canceled)

7. The method of claim 1, wherein transferring a portion of data from the first data path to the new data path comprises transferring an amount of data so that the first data path and the new data path are under the predetermined workload threshold.

8. The method of claim 1, wherein dynamically adjusting the workload of the first data path comprises:
transferring a portion of data from the first data path to a second data path;
creating a third data path; and
transferring a portion of data from the first data path to the third data path.

9. The method of claim 1, wherein determining if the monitored workload exceeds a predetermined workload threshold comprises determining if the monitored workload exceeds the predetermined workload threshold for a predetermined period of time.

10. A dynamic workload management computing system, comprising:
multiple cells that communicate data through data paths;
a workload monitor that monitors a workload of the data paths; and
a management controller that receives a data path workload information from the workload monitor and dynamically adjusts the workload and creates at least a new path.

11. The system of claim 10, further comprising:
a memory location that is local to each of the multiple cells or central to all of the multiple cells.

12. The system of claim 10, wherein the workload is an amount of traffic on the data paths.

13. The system of claim 10, wherein the workload monitor is local to each of the multiple cells.

14. The system of claim 10, wherein each cell comprises at least one processor.

15. The system of claim 10, wherein the workload monitor compares the workload of a path to a predetermined workload threshold, and wherein the path workload information from the workload monitor comprises an indication that the workload of the path exceeds the predetermined workload threshold.

16. A workload management computer controller, comprising:
an information retrieval component for receiving monitored workload information between a first cell and a second cell;
a determination component for deciding to dynamically readjust the monitored workload between the first cell and the second cell; and
a dynamic readjustment component for dynamically readjusting the monitored workload between the first cell and the second cell and for creating at least a new path.

17. The workload management controller of claim 16, wherein the information retrieval component receives the monitored workload information between the first cell and the second cell from one of a first workload monitor of the first cell and a second workload monitor of the second cell.

18. The workload management controller of claim 16, wherein the dynamic readjustment component dynamically readjusts the monitored workload if the information retrieval component receives an indication that the monitored workload of a first path between the first cell and the second cell exceeds a predetermined workload threshold.

19. The workload management controller of claim 16, wherein the determination component waits a predetermined period of time before deciding to dynamically readjust the monitored workload between the first cell and the second cell.

20. The workload management controller of claim 16, wherein the dynamic readjustment component dynamically readjusts the monitored workload between the first cell and the second cell by one of (i) transferring a portion of data from a first data path to a second data path; (ii) transferring a portion of data from a first data path to the new data path; and (iii) transferring a portion of data from a first data path to a second data path and transferring a portion of data from the first data path to the new data path.
